(19) United States
(12) Patent Application Publication
(10) Pub. No.: US 2024/0087215 A1
(43) Pub. Date: Mar. 14, 2024

(54) METHOD FOR GENERATING AN ADVANCED SURROUND VIEW AND ADVANCED SURROUND VIEW MONITORING SYSTEM

(71) Applicant: VINAI ARTIFICIAL INTELLIGENCE APPLICATION AND RESEARCH JOINT STOCK COMPANY, Ha Noi (VN)

(72) Inventors: Dai Thanh PHAN, Ha Noi (VN); Phuc Thien NGUYEN, Ha Noi (VN); Chi Thanh NGUYEN, Ha Noi (VN); Duc Chan VU, Ha Noi (VN); Truong Trung Tin NGUYEN, Ha Noi (VN); Dang Quang NGUYEN, Ha Noi (VN); Hai Hung BUI, Ha Noi (VN)

(21) Appl. No.: 18/494,820

(22) Filed: Oct. 26, 2023

Related U.S. Application Data
(63) Continuation-in-part of application No. PCT/IB2022/058604, filed on Sep. 13, 2022.

(51) Int. Cl. G06T 15/20; B60R 1/27; G06T 7/246; G06T 15/04; G06T 17/20; H04N 5/262

(52) U.S. Cl. CPC G06T 15/205; B60R 1/27; G06T 7/246; G06T 15/04; G06T 17/20; H04N 5/2624; B60K 37/06; G06T 2200/24; G06T 2207/10024; G06T 2207/20084; G06T 2207/30252; G06T 2210/22; G06T 2210/32; G06T 2210/62

(57) ABSTRACT

A system for generating an advanced surround view for a vehicle includes a plurality of cameras to generate image data. Sensors are configured to determine kinematic data of the vehicle. Kinematic data are also obtained by a visual odometry module and/or a deep-vision mechanism. A processor is configured to process image data captured by the plurality of cameras to generate a 360-degree surround view layer representative of a surrounding area. The processor is further configured to construct an improved bicycle kinematic model for processing kinematic data to generate an under-chassis layer representative of an area under the vehicle. The processor is further configured to generate a 3D vehicle model layer and overlay objects layer. Display screens display a GUI of combined scene of the 360-degree surround view layer, under-chassis layer, 3D vehicle model layer and overlay objects layer as would be viewed from a virtual camera viewpoint.

### CROSS-REFERENCE TO THE RELATED APPLICATION(S)

This application is a Continuation in-part of PCT/IB2022/058604 filed Sep. 13, 2022, which is incorporated herein by reference in its entirety.

### TECHNICAL FIELD

The present invention relates to a method for generating an advanced surround view for a vehicle and an advanced surround view monitoring system.

### RELATED ART

Recently, the demand for smart vehicles implementing a surround view monitoring system has rapidly increased. Surround view monitoring systems are known for providing a driver of a smart vehicle with a synthesized surround view of the environment and objects around the vehicle. The synthesized surround view may provide a plurality of viewpoints located, for example, in the exterior of the vehicle, and may be displayed on the display system of the vehicle in order for the driver to be aware of the surrounding of the vehicle while driving for enhanced safety. The driver can specifically select the desired viewpoint having a 360-degree range around the vehicle from the provided viewpoints.

The surround view monitoring system may equip a plurality of cameras (typically 4 fisheye cameras) mounted in the vehicle to capture images outward of the vehicle and along each of the sides of the vehicle, the cameras have respective fields of view outside of the vehicle. The captured images are then used to render the synthesized surround view around the vehicle. While rendering the synthesized surround view, the vehicle body is also rendered as a solid block. Thus, in the synthesized surround view, the vehicle body obscures a certain quantity of the field of view of the surround view monitoring system. A bird's eye view is the only case in which the vehicle's body does not interfere the field of view of the prior art surround view monitoring systems—which demands driver's intervene on a user input interface, for example, a Human-Machine Interface (HMI). Therefore, in avoiding the imminent collisions or in precise maneuvers such as parking next to curbs or passing by narrow road, the prior art surround view monitoring systems have limitations in that the driver has to manually switch the point-of-view to the bird's eye view mode so that the vehicle body does not interfere the field of view of these surround view monitoring systems. However, the bird's eye view has limitations with regard to highly distorted objects or objects that is very near to the vehicle.

Further, while rendering the synthesized surround view, an underneath area of the vehicle, which is referred to as a playground area hereinafter, cannot be observed due to the cameras geometric field of view limitation.

Another limitation concerns the environmental lighting conditions, current surround view monitoring systems find them self in difficulty with low brightness conditions and rely solely on camera device capability.

Therefore, there is a need for an improved surround view monitoring system and method that is capable of utilizing the entire of the field of view of the cameras equipped in the system without being obstructed from the rendering of the vehicle body, and capable of helping the driver of the vehicle to observe the playground area under the vehicle for tough driving conditions.

Specially, all of surround view monitoring systems are currently designed as a closed-system that can only interact with predefined systems and interfaces. With a huge number of advanced driving assistance system, artificial intelligence, computer vision applications that can run in a vehicle, surround view monitoring systems needs to be disposed of Application Programming Interface (API) allowing interaction with other vehicle systems or applications, via get-and-set APIs for input and output data flows.

### SUMMARY

The invention has been made to solve the above-mentioned problems, and an object of the invention is to provide an advanced surround view monitoring system and method that is capable of utilizing the entire of the field of view of the cameras equipped in the system without being obstructed from the rendering of the vehicle body. Thus, the system according to the invention helps the driver to observe simultaneously vehicle body and the surrounding without losses of multi-cameras system field of view, thereby help the driver to have better view on objects or human—including children—which are very close to the vehicle (e.g., vehicle's left/right, rear-bumper, front-bumper) or in blind-spot zones. The driver therefore can precisely make maneuvers and avoid risk of collision from imminent collision of very close objects/human or potential collisions with further objects/human, leading to potential accidents or car damages. Furthermore, this helps the driver to avoid collisions with children or low-height objects that cannot be observed by drivers directly or via mirrors. Moreover, the system according to the invention helps the driver to observe the playground area under the vehicle body for tough driving conditions.

This invention allows to construct an improved bicycle kinematic model transformed from four-wheel vehicle model matching reality.

This invention allows gradual integration of advanced image processing modules without re-implementation of surround view monitoring system itself, thanks to get-and-set API allowing data flow exchange from and to surround view monitoring system. Hence, advanced image processing modules can be integrated independently outside of surround view monitoring system, they get images feeding from surround view monitoring system via get-API, they process those images, then send back to surround view monitoring system via set-API.

According to an aspect of the invention, there is provided a method for generating an advanced surround view for a vehicle, the method comprising:
generating image data using a plurality of cameras mounted at the vehicle; wherein the plurality of cameras have respective fields of view exterior of the vehicle;
generating kinematic data using at least one sensor mounted at the vehicle, and/or at least one visual odometry module and/or at least one neural network mechanism of the vehicle;
processing the kinematic data to compute a moving distance, a rotation matrix, a translation vector representing of a movement of the vehicle;
generating a 360-degree surround view layer showing a 360-background image around the vehicle constructed from the image data;
generating an under-chassis layer showing an area located in the under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of a user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing a Graphic User Interface (GUI) into the 360-degree comprehensive and intuitive perspective scene to be displayed on at least one display device;
listening controls signal from at least one input device to enable controls:
to change the point of observation,
to adjust properties of 3D vehicle model, and
to enable/disable said integrated external image processing modules; and
updating rendering parameters in the GUI.

According to another aspect of the invention, there is provided an advanced surround view monitoring system, the system comprising:
a plurality of cameras mounted at a vehicle configured to provide image data, wherein the plurality of cameras have respective fields of view exterior of the vehicle;
at least one sensor at the vehicle, at least one visual odometry module and at least one neural network mechanism, wherein the at least one sensor, the at least one visual odometry module and/or the at least one neural network mechanism are configured to determine kinematic data of the vehicle;
a storage for storing camera data comprising extrinsic parameters, intrinsic parameters and the image data, kinematic data, data of three-dimensional representations and overlay objects;
at least one display device configured to display a Graphic User Interface (GUI);
at least one input device configured to receive controls from a user; and
a processor configured for:
generating image data from the plurality of cameras;
generating kinematic data using the at least one sensor, and/or the at least one visual odometry module and/or the at least one neural network mechanism;
processing the kinematic data for computing a moving distance, a rotation matrix, a translation vector representing of a movement of the vehicle;
generating a 360-degree surround view layer showing a 360-background image around the vehicle constructed from the image data;
generating an under-chassis layer showing an area located in the under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of the user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing the GUI into the 360-degree comprehensive and intuitive perspective scene to be displayed on at least one display device;
listening controls signal from the at least one input device to enable controls:
to change the point of observation,
to adjust properties of 3D vehicle model, and
to enable/disable said integrated external image processing modules; and
updating rendering parameters in the GUI.

### BRIEF DESCRIPTION OF THE DRAWINGS

The above and other objects, features and advantages of the invention will become more apparent to those of ordinary skill in the art by describing exemplary embodiments thereof in detail with reference to the accompanying drawings, in which:

FIG. 1 shows an example scene of an advanced surround view monitoring system;

FIG. 2 is a block diagram showing an example of an advanced surround view monitoring system;

FIG. 3 is a block diagram of an example method for generating an advanced surround view;

FIG. 4 illustrates separated layers in a scene of an advanced surround view monitoring system;

FIG. 5 is a flow diagram of kinematic data processing;

FIG. 6 is a flow diagram of an example method of generating a 360-degree surround view layer;

FIG. 7 is a flow diagram of an example method of generating an under-chassis layer;

FIGS. 8-10 show surround views for the vehicle from different virtual camera viewpoints;

FIG. 11 illustrates an improved kinematic model constructed from a four-wheel vehicle model;

FIG. 12 shows a relative position between an old playground layer and a new playground layer; and

FIG. 13 illustrates an example of fulfilling under-chassis image.

### DETAILED DESCRIPTION

While the invention may have various modifications and alternative forms, specific embodiments thereof are shown by way of example in the drawings and will be described herein in detail. However, there is no intent to limit the invention to the particular forms disclosed. On the contrary, the invention is to cover all modifications, equivalents, and alternatives falling within the spirit and scope of the appended claims.

It should be understood that, although the terms “first,” “second,” and the like may be used herein to describe various elements, the elements are not limited by the terms. The terms are only used to distinguish one element from another element. For example, a first element could be termed a second element, and, similarly, a second element could be termed a first element without departing from the scope of the invention. As used herein, the term “and/or” includes any and all combinations of one or more of the associated listed items.

The terminology used herein is for the purpose of describing particular embodiments only and is not intended to be limiting to the invention. As used herein, the singular forms “a,” “an,” “another,” and “the” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

A vehicle as described in this disclosure may include, for example, a car, a truck, a bus, a ship or a motorcycle, or any suitable motorized vehicle, for example, the vehicle applied in maritime, workload handling machine, aviation and space. Hereinafter, a car will be described as an example.

A vehicle as described in this disclosure may be powered by any suitable power source, and may be, for example, an internal combustion engine vehicle including an engine as a power source, a hybrid vehicle including both an engine and an electric motor as a power source, and/or an electric vehicle including an electric motor as a power source.

As used herein, a texture refers to a graphics data structure which models the surface appearance of an object. A texture may represent the visual experience of many materials and substances. Textures may be created digitally by sampling a physical surface utilizing photographic techniques. Alternatively, textures may be created manually utilizing a suitable graphics design application.

Hereinafter, embodiments will be described in detail with reference to the accompanying drawings, the same or corresponding components are denoted by the same reference numerals regardless of reference numbers, and thus the description thereof will not be repeated.

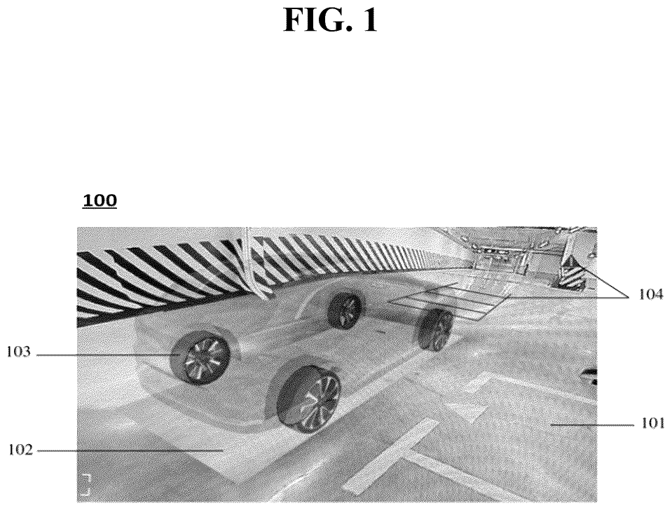

FIG. 1. shows an example scene of an advanced surround view monitoring system 100 of a vehicle, the system 100 comprises a 360-degree surround view layer 101, an under-chassis layer 102, a 3D vehicle model layer 103 and an overlay objects layer 104, wherein users can adjust point of observation.

The 360-degree surround view layer 101 shows a 360-degree background image around the vehicle, wherein the 360-degree background image is constructed from stitching images of a plurality of cameras. Moreover, via an Application Programming Interface (API), cameras images can be processed by external image processing modules such as photo metric alignment, low light enhancement, object detection modules.

The under-chassis layer 102 shows an area located under-chassis of the vehicle outside cameras field of view, wherein texture of the under-chassis layer 102 is constructed from historic image data and kinematic data.

The 3D vehicle model layer 103 shows the vehicle's position relative to the surround landscape, wherein a user can adjust properties of the 3D vehicle model. According to an embodiment, a portion or all of the 3D vehicle model layer 103 is rendered as displayed to be transparent to enable viewing at display screens a portion of the 360-degree surround view layer 101 and a portion of the under-chassis layer 102 and a portion of the overlay objects layer 104.

The overlay objects layer 104 may include, but not limited to, wheels guidelines, turning curves, distance levels indicator and/or collision warning such as icons indicating objects at risk of collision to provide the user with safety information.

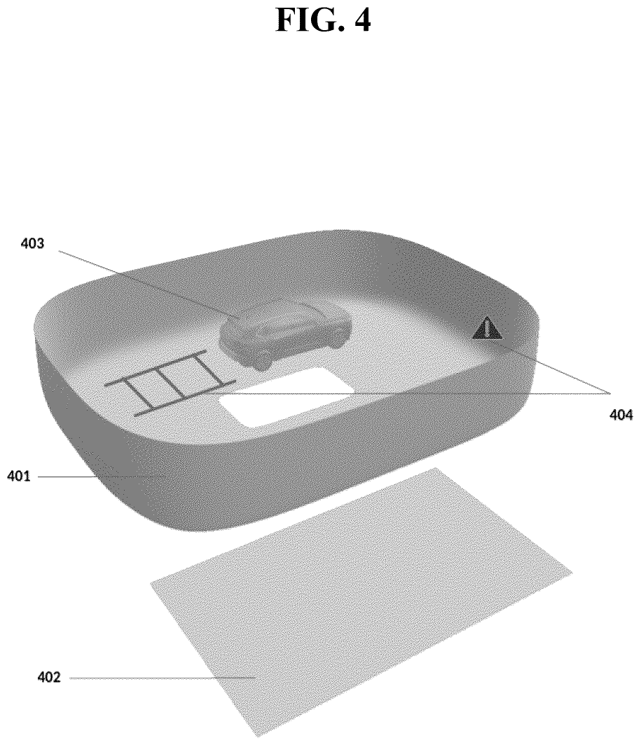

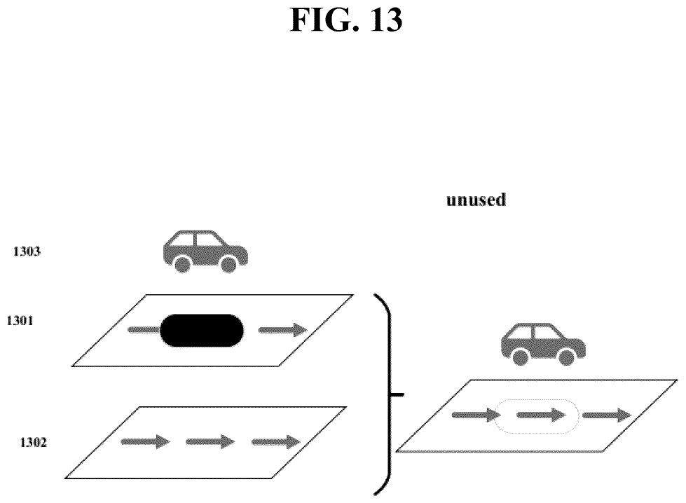

FIG. 4 illustrates separated layers in a scene of an advanced surround view monitoring system. In one embodiment of the present invention, the under-chassis layer 402 is rendered under the 360-degree surround view layer 401. The 3D vehicle model layer 403 and the overlay objects layer 404 are rendered as top layers. FIG. 13 illustrates an example of combining the 360-degree surround view layer 1301 and the under-chassis layer 1302 to fulfill under-chassis vehicle image. In FIG. 13, the 3D vehicle model layer is denoted as 1303.

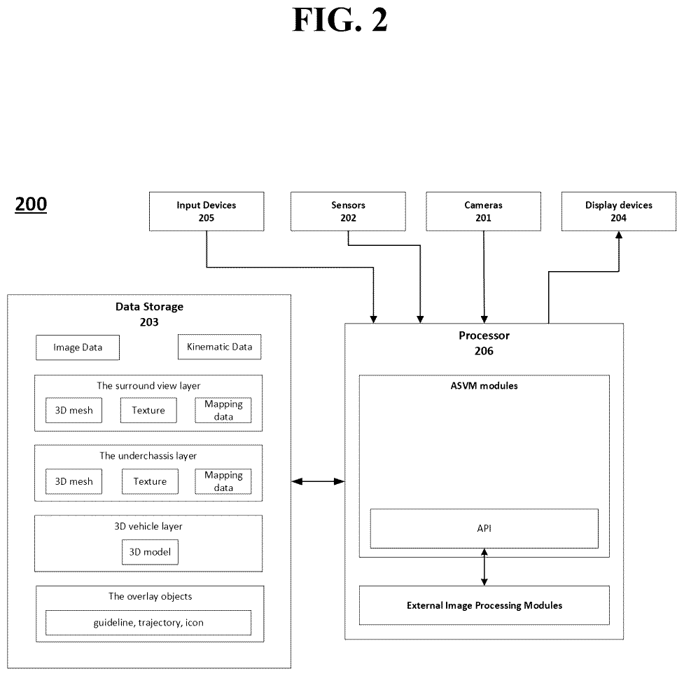

FIG. 2 illustrates a schematic diagram of an advanced surround view monitoring system (hereinafter referred to as the system 200).

In one embodiment of the present invention, system 200 comprises a plurality of cameras 201 including multiple exterior facing imaging sensors or cameras (such as a rearward facing imaging sensor, a forward facing camera at the front (or at the windshield) of the vehicle, and sideward facing cameras at respective sides of the vehicle), which capture images exterior of the vehicle. According to an embodiment, the plurality of cameras 201 comprise at least one front camera having a field of view forward of the vehicle, at least one rear camera having a field of view rearward of the vehicle, at least one left camera having a field of view left of the vehicle, and at least one right camera having a field of view right of the vehicle. The cameras 201 may provide image data as RGB/RGBA and/or other formats.

The plurality of cameras 201 may comprise optical image sensors, infrared sensors, long and short range RADAR, LIDAR, Laser, ultrasound sensors, and/or the like. The cameras typically use a wide focal width, commonly referred to as a fish eye lens or optic, for providing a wide angle field of view, typically about 180 degrees to about 220 degrees for each camera (such as for a four camera vision system). Typically, there are overlapping regions in the fields of view of the cameras. By providing such a wide angle field of view, the field of view of the cameras typically not only include the environment around the vehicle, but partially includes the vehicle's body as well, such as at the lateral regions of the captured images of each camera.

The system 200 further comprises a sensor system 202 that includes at least one vehicle's sensor that is configured to determine a moving direction, a moving distance and a rotation angle of wheels of the vehicle between successive measures of the wheel odometer. According to another embodiment, the vehicle's sensors may further comprise at least Inertial Measurement Unit (IMU) that is configured to determine an angular acceleration, a linear acceleration, an angular velocity between successive measures of the IMU of the vehicle. The IMU may have a six degree-of-freedom (DOF) configuration and have one gyroscope and one accelerometer for each of three orthogonal axes. The accelerometer is for detecting the specific force, and the gyroscope is for detecting the angular rate. Accordingly, the sensor system 202 provides kinematic parameters comprising information on the moving direction, the rotation angle of wheels of the vehicle, wheels speeds, angular acceleration, the linear acceleration, the angular velocity, yaw-pitch-roll rate, steering wheel angle, turning radius . . . .

The system 200 further comprises a storage 203 that may include at least one RAM, at least one hard drive (HDD/SSD), at least one flash disk, at least one SD card and/or other types of memory. The storage system provides memory for still data including camera parameters (intrinsic/extrinsic), vehicle 3D model, and data generated during process including camera image data, kinematic data, meshes, textures mapping data, data of three-dimensional representations and overlay objects comprising guideline, trajectory, icon.

The system 200 further comprises display devices 204 to display a graphic user interface. The display devices 204 are viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element, a projector, a head up display (HUD) or the like, and may be operable to display various information (as discrete characters, icons or the like, or in a multi-pixel manner) to the driver of the vehicle, such as passenger side inflatable restraint (PSIR) information, tire pressure status, and/or the like.

The system 200 further comprises input devices 205 to control. Input devices may include, but not limited to, at least one physical button, at least one keyboard, at least one joystick, at least one steering wheel, at least one gear stick, and/or at least one touch device integrated on display system (i.e., display devices 204).

The system 200 further comprises a processor 206 that is configured to implement modules for: generating image data from the plurality of cameras 201; generating kinematic data, processing kinematic data to compute parameters representing of vehicle's movement, generating a 360-degree surround view layer, generating an under-chassis layer, generating a 3D vehicle model layer, generating an overlay objects layer, listening controls signal from the input devices 205, updating rendering parameters, rendering Graphic User Interface (GUI) on the display devices 204 and implementing API for integration of external image processing modules.

Processor 206 refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

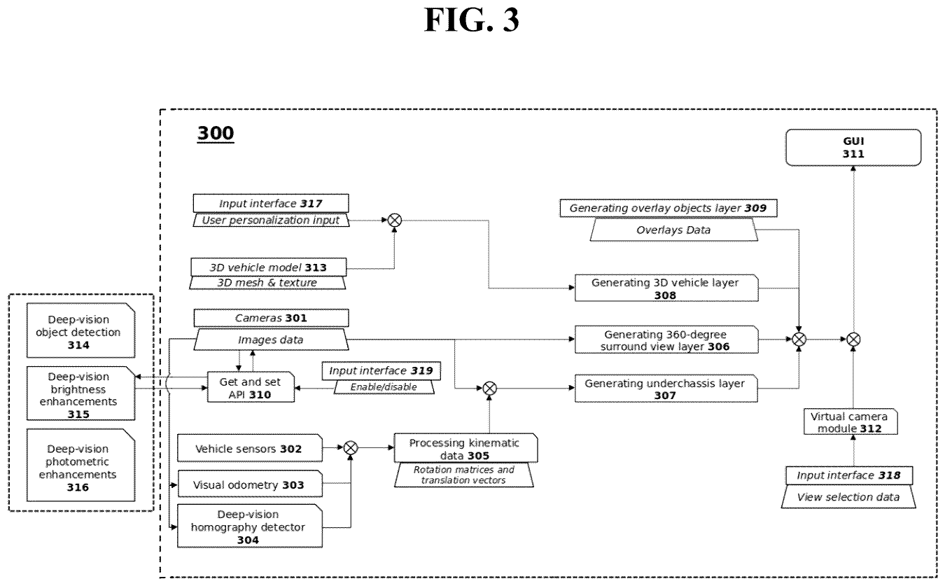

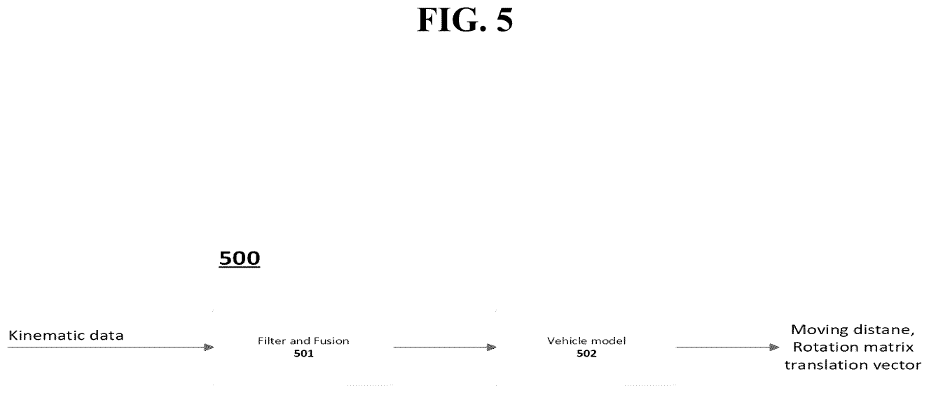

FIG. 3 is the block diagram showing a method for generating an advanced surround view for a vehicle (hereinafter referred to as the system 300). FIG. 3 is described with reference from FIG. 5 to FIG. 11.

Referring FIG. 3, a module of generating image data from a plurality of cameras 301 is configured to obtain streaming data from cameras. If the data is not RGBA format, and then convert it to RGBA; save the image data in a pre-declared memory area. The image data can be used by other modules via address of memory or variable name.

Continuing with FIG. 3, a module of generating kinematic data comprises 03 sub modules obtaining kinematic parameters in different ways.

A first sub-module kinematic sensor 302 is mounted at the vehicle and configured to obtain kinematic parameter from the sensor system.

A second sub-module visual odometry module 303 is configured to obtain camera image data, extract keypoint, and compare the movement of keypoints overtime to predict kinematic parameters.

A third sub-module is a neural network mechanism 304 which is configured to obtain camera image data as an input for a neural network model. The output of the model is predicted kinematic parameters.

All kinematic data is store in the pre-declared memory area and can be used by other modules via address of memory or variable name.

Continuing with FIG. 3, a module of processing kinematic data 305 is configured to generate a moving distance, a rotation matrix and a translation vector representing of vehicle's movement. The process 500 is illustrated in detail in FIG. 5.

At step 501, kinematic data passes a filter and a fusion model to eliminate effect of noises and return unique values for each parameter. In one embodiment of the present invention, the filter and the fusion model may be, not limited to, an Extended Kalman Filter.

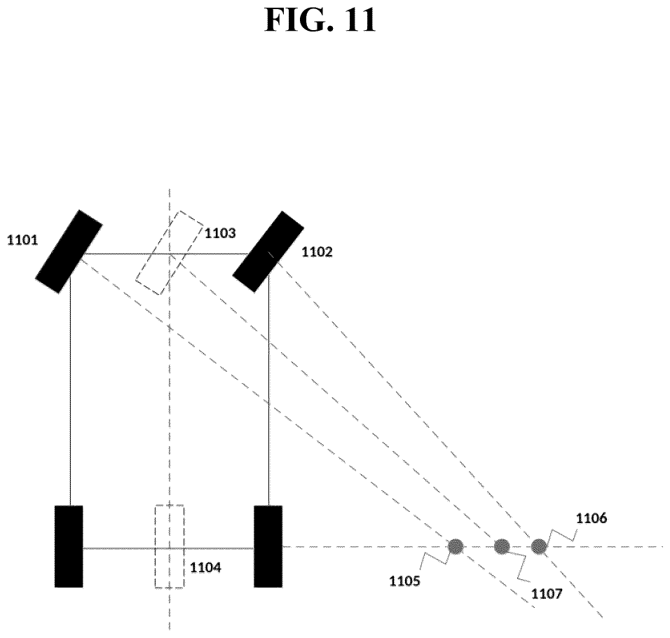

Next is step 502, kinematic data is fed into an improved bicycle kinematic model to compute the moving distance, the rotation matrix and the translation vector representing vehicle's movements. According to an embodiment, the improved bicycle kinematic model is constructed from a four-wheel vehicle model. FIG. 11 illustrates an improved bicycle kinematic model constructed from the four-wheel vehicle model. In particular, two front wheels of the four-wheel kinematic model are transformed into a virtual front wheel 1103 of the improved bicycle kinematic model located in the center of the two front wheels. Two rear wheels of the four-wheel kinematic model are transformed into a virtual rear wheel 1104 of the improved bicycle kinematic model located in the center of the two rear wheels. Point 1105 is the intersection of vehicle's front-left wheel 1101 axle and vehicle rear wheel axle. In addition, point 1106 is the intersection of vehicle's front-right wheel 1102 axle and vehicle rear wheel axle. Center of rotation 1107 of the improved bicycle kinematic model is determined to be the midpoint of point 1105 and point 1106.

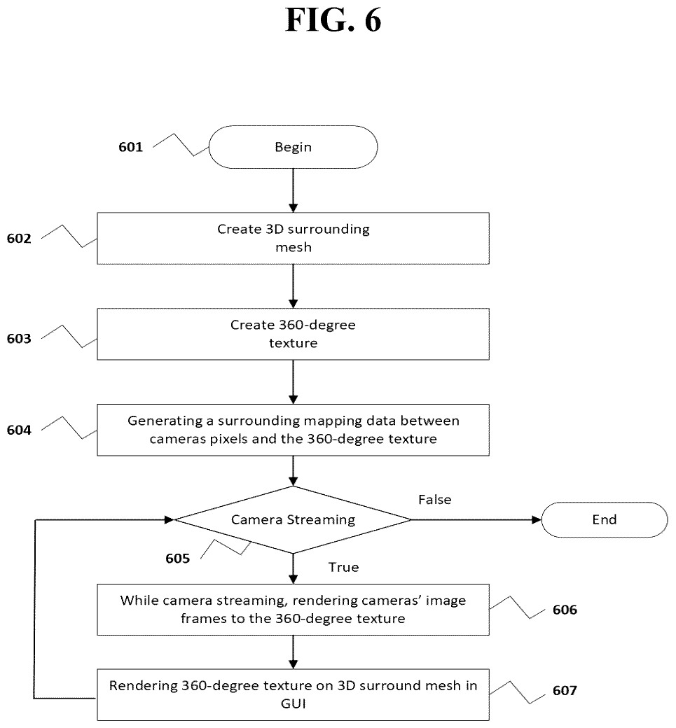

Continuing with FIG. 3, a module of generating 360-degree surround view layer 306 is provided to generate 360-degree data for rendering from stitching images of plurality of cameras located at different positions. Now, referring to FIG. 6, a flow chart illustrates a process of generating a 360-degree surround view layer in accordance with an embodiment of the present invention.

At step 601, the process begins.

At step 602, generating a 3D surround mesh as a geometry of bowl-shape around the vehicle, wherein an under-chassis area of the vehicle is cropped to make said under-chassis layer below visible.

At step 603, generating a 360-degree texture unwrapping on said 3D surround mesh.

At step 604, for each said camera, generating a 360-degree texture mapping data based on said 3D surround mesh, still intrinsic/extrinsic parameters and the virtual camera model, wherein the 360-degree texture mapping data is matched between pixels of cameras images and pixels of said 360-degree texture.

At step 605, checking if the camera system is streaming, continue step 606, otherwise end the process.

At step 606, rendering the newest camera image data to said 360-degree texture based on said 360-degree texture mapping data.

At step 607, rendering 360-degree texture on the 3D surround mesh in GUI and return to step 605.

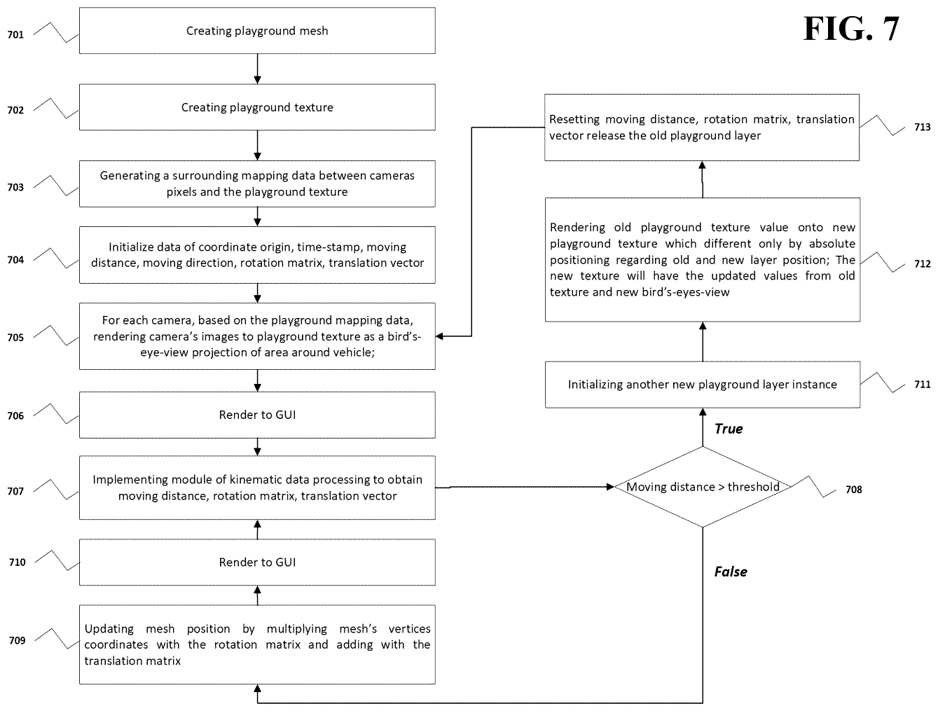

Continuing with FIG. 3, the module of generating an under-chassis layer 307 is configured to provide rendering data for area under-chassis of the vehicle. Now, referring to FIG. 7, a flow chart illustrates a process of generating an under-chassis layer in accordance with an embodiment of the present invention.

At step 701, generating a playground mesh, wherein vertices form a geometry of a horizontal plane at zero altitude around the vehicle. Dimensions of the playground mesh is significantly larger than the width and length of the vehicle at least two times.

At step 702, generating a playground texture unwrapping on said playground mesh.

At step 703, for each said camera, generating a playground texture mapping data on said playground mesh, still intrinsic/extrinsic parameters and the virtual camera model, wherein mapping data is matched between pixels of cameras images and pixels of playground texture.

At step 704, initializing data of coordinate origin, time-stamp, moving distance, moving direction, rotation matrix, translation vector.

At step 705, rendering the newest camera image data to said playground texture based on said playground texture mapping data, as a bird's-eye-view projection of area around the vehicle.

At step 706, rendering the playground texture on the playground mesh in the GUI.

At step 707, implementing module of kinematic data processing 305 (FIG. 3) to obtain moving distance, rotation matrix, translation vector.

At step 708, checking if the moving distance does not exceed a predefined distance threshold, performing steps 709 and step 710 then returning to step 707; otherwise, performing steps 711, 712, 713 then returning to step 705.

At step 709, updating mesh position (i.e., the position of the playground mesh) opposite the vehicle's moving direction by implementing a linear algebraic operation between playground mesh's vertices coordinates and the rotation matrix and the translation vector.

At step 710, rendering the playground texture on the playground mesh in the GUI, then returning to step 707.

At step 711, initializing another new playground layer instance.

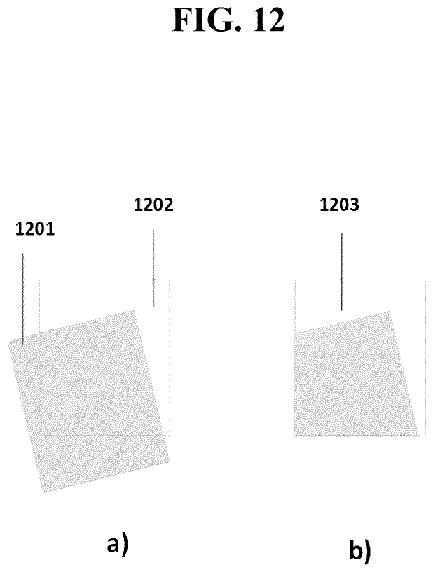

At step 712, rendering old playground texture value into new playground texture wherein difference only by relative position of old and new playground mesh. As an example, FIG. 12 shows a) relative position between an old playground layer 1201 and a new playground layer 1202; and b) a new playground layer 1203 after step 712.

At step 713, finishing a cycle of loop, resetting the mesh position and data of coordinate origin, timestamp, moving distance, rotation matrix, and translation vector and releasing the old playground texture then returning to step 705 to start a new cycle.

Continuing with FIG. 3, a module of generating a 3D vehicle model layer 308 is configured to provide rendering data for the vehicle. The 3D vehicle model layer is displayed as 103 of FIG. 1. The 3D vehicle model layer is generated based on a pre-configured three-dimensional vehicle model 313 comprising a 3D vehicle mesh with a shape and dimension of the vehicle and a texture unwrapping the mesh so that the 3D vehicle model layer that is representative of the vehicle is actually similar (such as in body type or style and/or car line and/or color) to the actual vehicle equipped with the system 200.

Continuing with FIG. 3, a module of generating the overlay objects 309 is provided to generate rendering data comprising guideline, trajectory, indicators, and collision warning icons. Overlay objects may be static objects and/or dynamic objects generated by object detection module, segmentation module, lane detection module.

Continuing with FIG. 3, an API 310 is configured to flexibly integrate external (and/or third party) image processing modules. In one embodiment of the present invention, said API 310 comprises a “GET” method is configured to retrieve the image data in the storage and provide for the external image processing modules and a “SET” method is configured to replace the image data in the storage by new image data returned from the external image processing modules.

Continuing with FIG. 3, a virtual camera module 312 is configured to generate virtual camera models for providing user point of observation. The virtual camera models may comprise a perspective camera model, and/or orthographic camera model.

Continuing with FIG. 3, a module of GUI 311 is provided to display a combined scene of the 360-degree surround view layer, the under-chassis layer, the 3D vehicle model layer and the overlay objects layer.

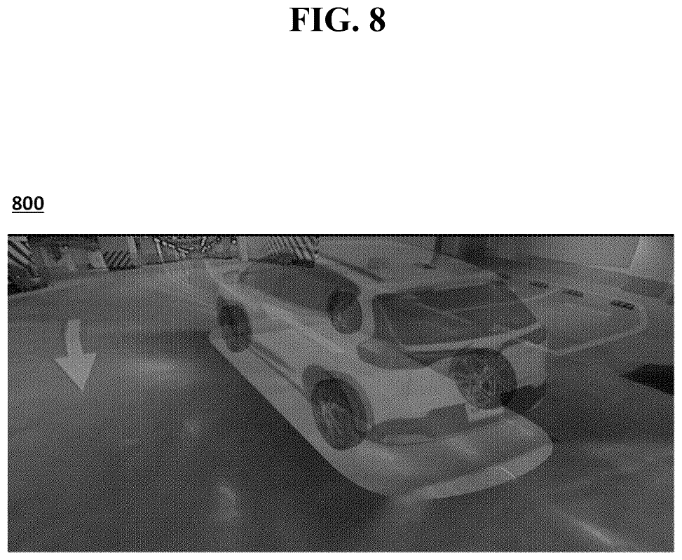

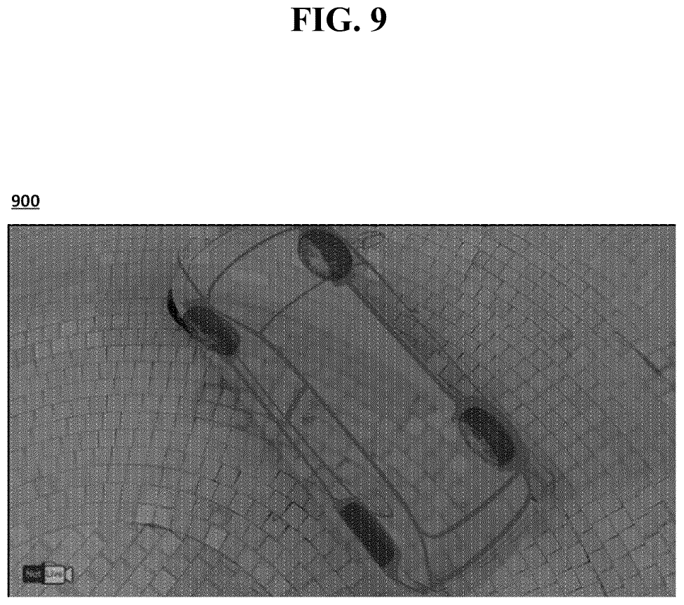

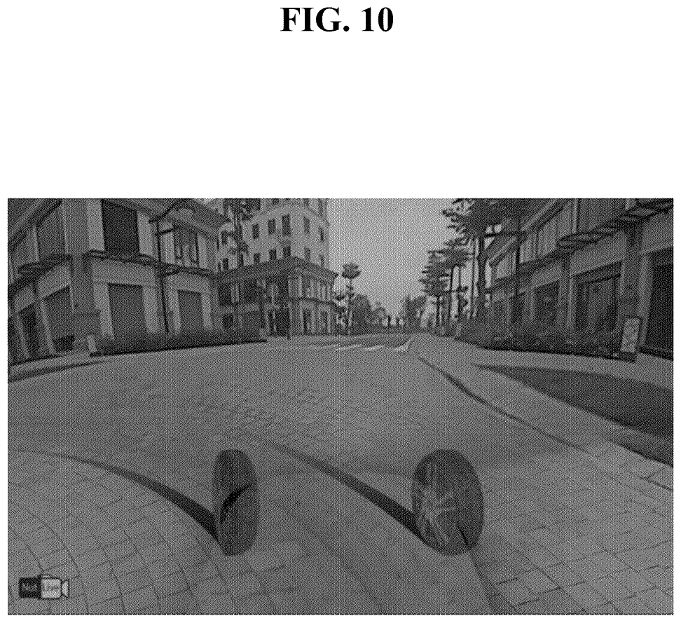

The module of GUI 311 is also provided with an input interface 318 to allow users to adjust the virtual camera module 312. The virtual camera viewpoint from which the combined representation is viewed may be (i) exterior to, higher than and rear-left or rear-right of the vehicle. As an example, FIG. 8 shows a surround view from the virtual camera viewpoint exterior to, higher than and rear-left of a vehicle 800. The virtual camera viewpoint from which the combined representation is viewed may be (ii) exterior to, higher than and top-down of the vehicle. As an example, FIG. 9 shows a surround view (or bird's eye view) from the virtual camera viewpoint exterior to, higher than and top-down of a vehicle 900. The virtual camera viewpoint from which the combined representation is viewed may be (iii) interior with a field of view forward of the vehicle, and (iv) interior with a field of view rearward of the vehicle as shown in FIG. 10. According to an embodiment, user can change point of observation by pushing a button, rotating a steering wheel, changing a gear stick, and/or touching on a touch-screen.

The module of GUI 311 is also provided with an input interface 317 to allow users to adjust properties of the 3D vehicle model comprising at least one of a degree of transparency, a texture, a color and a decoration of a portion/or all of the 3D vehicle model.

Moreover, the module of GUI 311 is also provided with an input interface 319 to allow the users to enable/disable API for integrating external image processing module.

Optionally, the method 300 further comprises a deep vision object detection mechanism 314 operable of detecting objects in images captured from the plurality of cameras 301 that would be potential to collide with the vehicle and emphasizing the object on the display screen.

Optionally, the method 300 further comprises a deep vision brightness enhancement mechanism 315 operable of augmenting a brightness of images captured from the plurality of cameras 301 when the driving condition is in low lighting.

Optionally, the method 300 further comprises a deep vision photometric enhancement mechanism 316 operable of equalizing and balancing image quality of a plurality of images captured from the plurality of cameras 301. The image quality comprises brightness, color, tone.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example, there is provided a method for generating an advanced surround view for a vehicle, the method comprising:
generating image data using a plurality of cameras mounted at the vehicle; wherein the plurality of cameras have respective fields of view exterior of the vehicle;
generating kinematic data using at least one sensor mounted at the vehicle, and/or at least one visual odometry module and/or at least one neural network mechanism of the vehicle;
processing the kinematic data to compute a moving distance, a rotation matrix, a translation vector representing of a movement of the vehicle;
generating a 360-degree surround view layer showing a 360-background image around the vehicle constructed from the image data;
generating an under-chassis layer showing an area located under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of a user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing a Graphic User Interface (GUI) into the 360-degree comprehensive and intuitive perspective scene to be displayed on at least one display device;
listening controls signal from at least one input device to enable controls:
to change the point of observation,
to adjust properties of 3D vehicle model, and
to enable/disable said integrated external image processing modules; and
updating rendering parameters in the GUI.

In some embodiments, the step of generating the image data comprises:
accessing the plurality of cameras to obtain camera-streaming data;
if the format of the camera-streaming data is not RGB/RGBA, converting the camera-streaming data to RGB/RGBA format; and
storing the camera-streaming data to a storage.

In some embodiments, the step of generating the kinematic data comprises:
accessing the at least one sensor to obtain the kinematic data;
implementing the at least one visual odometry module to obtain the kinematic data;
implementing the at least one neural network mechanism to obtain the kinematic data; and
storing the kinematic data to a storage.

In some embodiments, the kinematic data comprises moving direction, vehicle speed, wheel speeds, acceleration, angular velocity, yaw-pitch-roll rate, wheel turning angles, steering angle, turning radius.

In some embodiments, the at least one visual odometry module is implemented for:
accessing the storage to obtain the newest camera image data;
extracting descriptive keypoints by using image processing algorithms;
predicting the kinematic data by calculating the positions changing of the descriptive keypoints while the vehicle is moving; and
storing the kinematic data to the storage.

In some embodiments, the at least one deep neural network mechanism comprises a deep neural network which is implemented for:
accessing the storage to obtain the newest camera image data;
predicting the kinematic data while the vehicle is moving; and
storing the kinematic data to the storage.

In some embodiments, the step of processing the kinematic data to compute the moving distance, the rotation matrix, the translation vector comprises:
retrieving the kinematic data from the storage;
implementing a noise filter and/or a data processing algorithm and/or a statistical algorithm and/or a data fusion algorithm to obtain the output kinematic data;
constructing an improved bicycle kinematic model based on still vehicle geometry parameters including width, length, wheel base length; and
computing the moving distance, the rotation matrix and the translation vector based on the kinematic data and the improved bicycle kinematic model.

In some embodiments, the noise filter is an Extended Kalman Filter.

In some embodiments, the constructing of the improved bicycle kinematic model comprises using a four-wheel vehicle model, wherein: two front wheels of the four-wheel vehicle model are translated into a virtual front wheel within the improved bicycle kinematic model, positioned at the midpoint of the two front wheels; the two rear wheels of the four-wheel vehicle model are translated into a virtual rear wheel within the improved bicycle kinematic model, positioned at the midpoint of the two rear wheels; the center of rotation of the improved bicycle kinematic model is determined as the midpoint of: a) the intersection of the front-left wheel axle and the rear wheel axle of the vehicle, and b) the intersection of the front-right wheel axle and the rear wheel axle of the vehicle.

In some embodiments, the step of generating the 360-degree surround view layer comprises:
a) creating a 3D surround mesh as a geometry of bowl-shape around the vehicle, wherein an under-chassis area of the vehicle is cropped to make the under-chassis layer below visible;
b) creating a 360-degree texture unwrapping on the 3D surround mesh;
c) for each camera in the plurality of cameras, generating 360-degree texture mapping data based on the 3D surround mesh, intrinsic parameters, extrinsic parameters and the virtual camera model, wherein the 360-degree texture mapping data is matched between pixels of cameras images and pixels of the 360-degree texture;
d) if the camera is streaming, going to step (e), otherwise ending the step of generating the 360-degree surround view layer;
e) rendering the newest camera image data to the 360-degree texture; and
f) rendering the 360-degree texture on the 3D surround mesh in the GUI, then returning to step (d) for a new cycle.

In some embodiments, the step of generating the under-chassis layer comprises:
a) creating a playground mesh, whose vertices form a geometry of a horizontal plane at zero altitude, wherein dimensions of the playground mesh are designed exceeding at least two times the dimensions of the vehicle and covers an underneath area of the vehicle lying outside the field of view of the camera;
b) creating a playground texture unwrapping on the playground mesh;
c) for each camera in the plurality of cameras, generating a playground texture mapping data based on the playground mesh, intrinsic parameters, extrinsic parameters and the virtual camera model, wherein the playground texture mapping data is matched between pixels of cameras images and pixels of the playground texture;
d) initializing data of coordinate origin, time-stamp, moving distance, moving direction, rotation matrix, translation vector;
e) for each camera, rendering the newest camera image data to the playground texture, based on the playground texture mapping data, as a bird's-eye-view projection of area around the vehicle;
f) rendering the playground texture on the playground mesh in the GUI;
g) processing the kinematic data to obtain the moving distance, the rotation matrix, the translation vector;
h) if moving distance does not exceed a pre-configured distance threshold, performing next steps (i) and (j), otherwise performing steps (k), (l) and (m);
i) updating the position of the playground mesh opposite to the moving direction of the vehicle by implementing a linear algebraic operation between vertices coordinates of the playground mesh and the rotation matrix and the translation vector;
j) rendering the playground texture on the playground mesh in the GUI, then returning to step (h);
k) initializing another new playground layer instance;
l) rendering old playground texture value into new playground texture whose difference is only by relative position of old and new playground mesh, wherein the new playground texture have the updated values from old playground texture and new birds-eye-view; and
m) resetting the position of the playground mesh and the data of coordinate origin, timestamp, moving distance, rotation matrix and translation vector and releasing the old playground texture, then returning to step e) for a new cycle.

In some embodiments, the 3D vehicle model layer comprises:
a pre-configured 3D vehicle mesh with shape and dimension of the vehicle; and
a pre-configured texture unwrapping the pre-configured 3D vehicle mesh, wherein the pre-configured texture has image and color of the vehicle; wherein a portion or all of the 3D vehicle model layer is rendered as displayed to be transparent, wherein the transparency can be adjusted by changing opacity of the texture via the graphic user interface (GUI).

In some embodiments, the overlay objects layer comprises wheels guide lines, turning curves, distance level indicators, and/or icons indicating objects at risk of collision.

In some embodiments, the virtual camera model comprises at least one perspective camera model and/or at least one orthographic camera model.

In some embodiments, the graphic user interface (GUI) includes:
a combined scene comprising the 360-degree surround view layer, the under-chassis layer, the 3D vehicle model layer, and the overlay objects layer, wherein the combined scene mimics the 360-degree comprehensive and intuitive perspective scene from a virtual camera positioned as: (i) exterior, higher than, and rear-left or rear-right of the vehicle, (ii) exterior, higher than, and top-down of the vehicle, (iii) interior, with a forward field of view from the vehicle and (iv) interior, with a rearward field of view from the vehicle;
a 3D vehicle model layer, either partially or entirely, rendered with transparency, allowing users to view portions of the 360-degree surround view layer and the under-chassis layer on the display screen;
an input interface configured to gather user commands through input devices, wherein the user commands include specifications for the degree of transparency, texture type, color, and decoration of the 3D vehicle model layer, wherein the degree of transparency, texture, color, and decoration of the 3D vehicle model layer is adjusted based on the user commands;
an input interface configured to receive the user commands through the at least one input device to manipulate the virtual camera model, wherein the virtual camera model is modified according to the user commands; and
an input interface configured to collect the user commands via the at least one input device concerning the API module, wherein the external image processing modules are enabled or disabled based on the user commands.

In some embodiments, the Application Programming Interface (API) comprises:
a “GET” method that is configured to retrieve the image data in the storage and provide the external image processing modules; and
a “SET” method that is configured to replace the image data in storage by new image data returned from the external image processing modules.

According to a second example, there is provided an advanced surround view monitoring system, the system comprising:
a plurality of cameras mounted at a vehicle configured to provide image data, wherein the plurality of cameras have respective fields of view exterior of the vehicle;
at least one sensor at the vehicle, at least one visual odometry module and at least one neural network mechanism, wherein the at least one sensor, the at least one visual odometry module and/or the at least one neural network mechanism are configured to determine kinematic data of the vehicle;
a storage for storing camera data comprising extrinsic parameters, intrinsic parameters and the image data, kinematic data, data of three-dimensional representations and overlay objects;
at least one display device configured to display a Graphic User Interface (GUI);
at least one input device configured to receive controls from a user; and
a processor configured to implement modules for:
generating image data from the plurality of cameras;
generating kinematic data using the at least one sensor, and/or the at least one visual odometry module and/or the at least one neural network mechanism;
processing the kinematic data for computing a moving distance, a rotation matrix, a translation vector representing of a movement of the vehicle;
generating a 360-degree surround view layer showing a 360-background image around the vehicle constructed from the image data;
generating an under-chassis layer showing an area located under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of the user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing the GUI into the 360-degree comprehensive and intuitive perspective scene to be displayed on at least one display device;
listening controls signal from the at least one input device to enable controls:
to change the point of observation,
to adjust properties of 3D vehicle model, and
to enable/disable said integrated external image processing modules; and
updating rendering parameters in the GUI.

In some embodiments, the plurality of cameras comprises: at least one front camera having a field of view forward of the vehicle, at least one rear camera having a field of view rearward of the vehicle, at least one left camera having a field of view left of the vehicle, and at least one right camera having a field of view right of the vehicle.

In some embodiments, the at least one sensor comprises:
at least one wheel odometer configured to determine a moving direction, a moving distance and a rotation angle of wheels of the vehicle between successive measures of the at least one wheel odometer; and
at least one Inertial Measurement Unit (IMU) configured to determine an angular acceleration, a linear acceleration, an angular velocity of the vehicle between successive measures of the at least one IMU.

In some embodiments, the storage comprises at least one RAM (Random Access Memory), at least one hard drive (HDD/SSD), at least one flash disk, at least one SD card and/or other types of memory.

In some embodiments, the at least one display device comprises at least one screen, at least one projector and/or at least one head up display device.

In some embodiments, the at least one input device comprises at least one physical button, at least one keyboard, at least one joystick, at least one steering wheel, at least one gear stick, and/or at least one touch screen connected to display system.

According to a third example, there is provided a non-transitory computer readable medium encoded with instructions, which when executed by a computer, perform at least:
generating image data from a plurality of cameras mounted at a vehicle; wherein the plurality of cameras have respective fields of view exterior of the vehicle;
generating kinematic data from at least one sensor mounted at the vehicle and/or at least one visual odometry module and/or at least one deep neural network module of the vehicle;
processing the kinematic data to compute a moving distance, a rotation matrix, a translation vector representing of a movement of the vehicle;
generating a 360-degree surround view layer showing a 360-background image around the vehicle constructed from the image data;
generating an under-chassis layer showing an area located under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of a user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing a GUI into the 360-degree comprehensive and intuitive perspective scene to be displayed on at least one display device;
listening controls signal from at least one input device to enable controls:
to change the point of observation,
to adjust properties of 3D vehicle model, and
to enable/disable said integrated external image processing modules; and
updating rendering parameters in the GUI.

It will be appreciated that embodiments of the present invention can be realized in the form of hardware, software or a combination of hardware and software. Any such software may be stored in the form of volatile or non-volatile storage such as, for example, a storage device like a ROM, whether erasable or re-writable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine-readable storage storing such a program. Still further, embodiments of the present invention may be conveyed electronically via any medium such as a communication signal carried over a wired or wireless connection and embodiments suitably encompass the same.

While this specification contains many specific implementation details, these should not be construed as limitations on the scope of any invention or of what may be claimed, but rather as descriptions of features, that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for generating a surround view for a vehicle, the method comprising:
generating image data using a plurality of cameras mounted at the vehicle, wherein the plurality of cameras have respective fields of view exterior of the vehicle;
generating kinematic data using at least one sensor mounted at the vehicle, and/or at least one visual odometry module and/or at least one neural network mechanism of the vehicle;
processing the kinematic data to compute a moving distance, a rotation matrix, and a translation vector representative of a movement of the vehicle;
generating a 360-degree surround view layer showing a 360-background image around the vehicle constructed from the image data;
generating an under-chassis layer showing an area located under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of a user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing a Graphic User Interface (GUI) into the 360-degree comprehensive and intuitive perspective scene to be displayed on at least one display device;
receiving controls signal from at least one input device to enable controls to change the point of observation, to adjust properties of 3D vehicle model, and to enable/disable said integrated external image processing modules; and
updating rendering parameters in the GUI.

2. The method of claim 1, wherein the step of generating the image data comprises:
accessing the plurality of cameras to obtain camera-streaming data;
in response to the format of the camera-streaming data being not RGB/RGBA, converting the camera-streaming data to RGB/RGBA format; and
storing the camera-streaming data to a storage.

3. The method of claim 1, wherein the step of generating the kinematic data comprises:
accessing the at least one sensor to obtain the kinematic data;
implementing the at least one visual odometry module to obtain the kinematic data;
implementing the at least one neural network mechanism to obtain the kinematic data; and
storing the kinematic data to a storage.

4. The method of claim 3, wherein the kinematic data comprises at least one of moving direction, vehicle speed, wheel speeds, acceleration, angular velocity, yaw-pitch-roll rate, wheel turning angles, steering angle, or turning radius.

5. The method of claim 3, wherein the at least one visual odometry module is implemented for:
accessing the storage to obtain the newest camera image data;
extracting descriptive keypoints by using image processing algorithms;
predicting the kinematic data by calculating the positions changing of the descriptive keypoints while the vehicle is moving; and
storing the kinematic data to the storage.

6. The method of claim 3, wherein the at least one deep neural network mechanism comprises a deep neural network which is implemented for:
accessing the storage to obtain the newest camera image data;
predicting the kinematic data while the vehicle is moving; and
storing the kinematic data to the storage.

7. The method of claim 1, wherein the step of processing the kinematic data to compute the moving distance, the rotation matrix, and the translation vector comprises:
retrieving the kinematic data from the storage;
implementing a noise filter and/or a data processing algorithm and/or a statistical algorithm and/or a data fusion algorithm to obtain the output kinematic data;
constructing an improved bicycle kinematic model based on still vehicle geometry parameters including width, length, or wheel base length; and
computing the moving distance, the rotation matrix, and the translation vector based on the kinematic data and the improved bicycle kinematic model.

8. The method of claim 7, wherein the noise filter is an Extended Kalman Filter.

9. The method of claim 7, wherein the constructing of the improved bicycle kinematic model comprises using a four-wheel vehicle model, wherein:
two front wheels of the four-wheel vehicle model are translated into a virtual front wheel within the improved bicycle kinematic model, positioned at the midpoint of the two front wheels;
the two rear wheels of the four-wheel vehicle model are translated into a virtual rear wheel within the improved bicycle kinematic model, positioned at the midpoint of the two rear wheels;
the center of rotation of the improved bicycle kinematic model is determined as the midpoint of: a) the intersection of the front-left wheel axle and the rear wheel axle of the vehicle, and b) the intersection of the front-right wheel axle and the rear wheel axle of the vehicle.

10. The method of claim 1, wherein the step of generating the 360-degree surround view layer comprises:
a) creating a 3D surround mesh as a geometry of bowl-shape around the vehicle, wherein an under-chassis area of the vehicle is cropped to make the under-chassis layer below visible;
b) creating a 360-degree texture unwrapping on the 3D surround mesh;
c) for each camera in the plurality of cameras, generating 360-degree texture mapping data based on the 3D surround mesh, intrinsic parameters, extrinsic parameters and the virtual camera model, wherein the 360-degree texture mapping data is matched between pixels of cameras images and pixels of the 360-degree texture;
d) in response to the camera being streaming, going to step (e), otherwise ending the step of generating the 360-degree surround view layer;
e) rendering the newest camera image data to the 360-degree texture; and
f) rendering the 360-degree texture on the 3D surround mesh in the GUI, then returning to step (d) for a new cycle.

11. The method of claim 1, wherein the step of generating the under-chassis layer comprises:
a) creating a playground mesh, whose vertices form a geometry of a horizontal plane at zero altitude, wherein dimensions of the playground mesh are designed exceeding at least two times the dimensions of the vehicle, and the playground mesh covers an underneath area of the vehicle lying outside the field of view of the camera;
b) creating a playground texture unwrapping on the playground mesh;
c) for each camera in the plurality of cameras, generating a playground texture mapping data based on the playground mesh, still intrinsic parameters, still extrinsic parameters and the virtual camera model, wherein the playground texture mapping data is matched between pixels of cameras images and pixels of the playground texture;
d) initializing data of coordinate origin, time-stamp, moving distance, moving direction, rotation matrix, and translation vector;
e) for each camera, rendering the newest camera image data to the playground texture, based on the playground texture mapping data, as a bird's-eye-view projection of area around the vehicle;
f) rendering the playground texture on the playground mesh in the GUI;
g) processing the kinematic data to obtain the moving distance, the rotation matrix, the translation vector;
h) in response to moving distance not exceeding a pre-configured distance threshold, performing next steps (i) and (j), otherwise performing steps (k), (l) and (m);
i) updating the position of the playground mesh opposite to the moving direction of the vehicle by implementing a linear algebraic operation between vertices coordinates of the playground mesh and the rotation matrix and the translation vector;
j) rendering the playground texture on the playground mesh in the GUI, then returning to step (h);
k) initializing another new playground layer instance;
l) rendering old playground texture value into new playground texture whose difference is only by relative position of old and new playground mesh, wherein the new playground texture have the updated values from old playground texture and new birds-eye-view; and
m) resetting the position of the playground mesh and the data of coordinate origin, timestamp, moving distance, rotation matrix, and translation vector and releasing the old playground texture, then returning to step e) for a new cycle.

12. The method of claim 1, wherein the 3D vehicle model layer comprises:
a pre-configured 3D vehicle mesh with shape and dimension of the vehicle; and
a pre-configured texture unwrapping the pre-configured 3D vehicle mesh,
wherein the pre-configured texture has image and color of the vehicle,
wherein a portion or all of the 3D vehicle model layer is rendered as displayed to be transparent, and
wherein the transparency is adjusted by changing opacity of the texture via the GUI.

13. The method of claim 1, wherein the overlay objects layer comprises wheels guidelines, turning curves, distance level indicators, and/or icons indicating objects at risk of collision.

14. The method of claim 1, wherein the virtual camera model comprises at least one perspective camera model and/or at least one orthographic camera model.

15. The method of claim 1, wherein the GUI includes:
a combined scene comprising the 360-degree surround view layer, the under-chassis layer, the 3D vehicle model layer, and the overlay objects layer, wherein the combined scene mimics the 360-degree comprehensive and intuitive perspective scene from a virtual camera positioned as: (i) exterior, higher than, and rear-left or rear-right of the vehicle, (ii) exterior, higher than, and top-down of the vehicle, (iii) interior, with a forward field of view from the vehicle and (iv) interior, with a rearward field of view from the vehicle;
a 3D vehicle model layer, either partially or entirely, rendered with transparency, allowing users to view portions of the 360-degree surround view layer and the under-chassis layer on the display screen;
an input interface configured to gather user commands through input devices, wherein the user commands include specifications for the degree of transparency, texture type, color, and decoration of the 3D vehicle model layer, wherein the degree of transparency, texture, color, and decoration of the 3D vehicle model layer is adjusted based on the user commands;
an input interface configured to receive the user commands through the at least one input device to manipulate the virtual camera model, wherein the virtual camera model is modified according to the user commands; and
an input interface configured to collect the user commands via the at least one input device concerning the API module, wherein the external image processing modules are enabled or disabled based on the user commands.

16. The method of claim 1, wherein the API comprises:
a “GET” method that is configured to retrieve the image data in the storage and provide the external image processing modules; and
a “SET” method that is configured to replace the image data in storage by new image data returned from the external image processing modules.

17. A surround view monitoring system, the system comprising:
a plurality of cameras mounted at a vehicle configured to provide image data, wherein the plurality of cameras have respective fields of view exterior of the vehicle;
at least one sensor at the vehicle, at least one visual odometry module and at least one neural network mechanism, wherein the at least one sensor, the at least one visual odometry module and/or the at least one neural network mechanism are configured to determine kinematic data of the vehicle;
a storage for storing camera data comprising extrinsic parameters, intrinsic parameters and the image data, kinematic data, data of three-dimensional representations and overlay objects;
at least one display device configured to display a Graphic User Interface (GUI);
at least one input device configured to receive controls from a user; and
a processor configured to implement modules for:
generating image data from the plurality of cameras;
generating kinematic data using the at least one sensor, and/or the at least one visual odometry module and/or the at least one neural network mechanism;
processing the kinematic data for computing a moving distance, a rotation matrix, and a translation vector representative of a movement of the vehicle;
generating a 360-degree surround view layer showing a 360-background image around the vehicle constructed from the image data;
generating an under-chassis layer showing an area located under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of the user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing the GUI into the 360-degree comprehensive and intuitive perspective scene to be displayed on at least one display device;
receiving controls signal from the at least one input device to enable controls to change the point of observation, to adjust properties of 3D vehicle model, and to enable/disable said integrated external image processing modules; and
updating rendering parameters in the GUI.

18. The system of claim 17, wherein the plurality of cameras comprises: at least one front camera having a field of view forward of the vehicle, at least one rear camera having a field of view rearward of the vehicle, at least one left camera having a field of view left of the vehicle, and at least one right camera having a field of view right of the vehicle.

19. The system of claim 17, wherein the at least one sensor comprises:
at least one wheel odometer configured to determine a moving direction, a moving distance and a rotation angle of wheels of the vehicle between successive measures of the at least one wheel odometer; and
at least one Inertial Measurement Unit (IMU) configured to determine an angular acceleration, a linear acceleration, an angular velocity of the vehicle between successive measures of the at least one IMU.

20. The system of claim 17, wherein the storage comprises at least one RAM (Random Access Memory), at least one hard drive (HDD/SSD), at least one flash dish, at least one SD card and/or other types of memory.

21. The system of claim 17, wherein the at least one display device comprises at least one screen, at least one projector and/or at least one head up display device.

22. The system of claim 17, wherein the at least one input device comprises at least one physical button, at least one keyboard, at least one joystick, at least one steering wheel, at least one gear stick, and/or at least one touch screen connected to display system.

23. A non-transitory computer readable medium containing instructions, which when executed by a processor, are configured to cause the processor to:
generating image data from a plurality of cameras mounted at a vehicle; wherein the plurality of cameras have respective fields of view exterior of the vehicle;
generating kinematic data from at least one sensor mounted at the vehicle and/or at least one visual odometry module and/or at least one deep neural network module of the vehicle;
processing the kinematic data to compute a moving distance, a rotation matrix, a translation vector representative of a movement of the vehicle;
generating a 360-degree surround view layer showing a 360-background image around the vehicle constructed from the image data;
generating an under-chassis layer showing an area located under-chassis of the vehicle outside field of view of the plurality of cameras using historic image data and kinematic data;
generating a 3D vehicle model layer showing a position of the vehicle relative to the surround landscape;
generating an overlay objects layer showing at least one guideline of wheels, at least one distance level map and/or at least one collision warning icon;
generating a virtual camera model to provide a point of observation of a user;
constructively combining the 360-degree surround view layer, the under-chassis layer, the 3D vehicle model layer, and the overlay objects layer to provide the user with a 360-degree comprehensive and intuitive perspective scene without blind spots;
providing an Application Programming Interface (API) for integration of external image processing modules into the 360-degree comprehensive and intuitive perspective scene;
providing a Graphical User Interface (GUI) into the 360-degree comprehensive and intuitive perspective scene to be displayed on at least one display device;
receiving controls signal from at least one input device to enable controls to change the point of observation, to adjust properties of 3D vehicle model, and to enable/disable said integrated external image processing modules; and
updating rendering parameters in the GUI.
